(19) United States
(12) Patent Application Publication
(10) Pub. No.: US 2025/0351762 A1
(43) Pub. Date: Nov. 20, 2025

(54) AUTOMATIC TRAVELING METHOD, AUTOMATIC TRAVELING PROGRAM, AND AUTOMATIC TRAVELING SYSTEM

(71) Applicant: Yanmar Holdings Co., Ltd., Osaka (JP)

(72) Inventors: Mamoru TAKAHASHI, Osaka (JP); Yasuto NISHII, Okayama (JP)

(73) Assignee: Yanmar Holdings Co., Ltd., Osaka (JP)

(21) Appl. No.: 19/207,001

(22) Filed: May 13, 2025

(30) Foreign Application Priority Data
May 14, 2024 (JP) 2024-078498

(51) Int. Cl. A01B 69/04; G05D 1/227; G05D 107/20

(52) U.S. Cl. CPC A01B 69/008; G05D 1/2274; G05D 2107/21

(57) ABSTRACT

A work vehicle can automatically travel according to an instruction output from a first operation terminal. A setting processing unit of the work vehicle sets whether to include, in the automatic traveling permission condition for permitting automatic traveling, a condition in which the communication state between the operation terminal and the work vehicle is a connection state where communication between the operation terminal and the work vehicle is established.

### TECHNICAL FIELD

The present invention relates to an automatic traveling technique for a work vehicle.

### BACKGROUND ART

In recent years, advancement in automation technology for agricultural machinery has led to introduction of work vehicles that perform works while automatically traveling in fields. In addition, a system in which an operator operates an operation terminal at a location away from a work vehicle to start or stop automatic traveling of the work vehicle has been known. For example, said system permits start of automatic traveling on condition that communication between the operation terminal and the work vehicle is established.

### PRIOR ART DOCUMENT

### Patent Document

Patent Document 1: Japanese Patent No. 6779164

### SUMMARY OF INVENTION

### Technical Problem

The communication state between an operation terminal and a work vehicle may become unstable depending on the usage environment. In conventional techniques, when the communication state becomes unstable and the communication between the operation terminal and the work vehicle is interrupted, automatic traveling cannot be started, or automatic traveling cannot be continued. Therefore, for example, even in an environment in which automatic traveling can be started by operating an operation unit provided in the work vehicle, when the communication between the operation terminal and the work vehicle is interrupted, start or continuation of automatic traveling is restricted, and a problem of deterioration of convenience in automatic traveling thus arises.

An object of the present invention is to provide an automatic traveling method, an automatic traveling program, and an automatic traveling system, capable of improving convenience in automatic traveling of a work vehicle.

### Solution to Problem

An automatic traveling method according to the present invention is a method capable of causing a work vehicle to automatically travel according to an instruction output from a first operation device. The automatic traveling method includes setting whether to include, in an automatic traveling permission condition for permitting automatic traveling, a condition in which a communication state between the first operation device and the work vehicle is a connection state where communication between the first operation device and the work vehicle is established.

An automatic traveling program according to the present invention is a program capable of causing a work vehicle to automatically travel according to an instruction output from a first operation device. The automatic traveling program is a program causing one or more processors to execute a process that sets whether to include, in an automatic traveling permission condition for permitting automatic traveling, a condition in which a communication state between the first operation device and the work vehicle is a connection state where communication between the first operation device and the work vehicle is established.

An automatic traveling system according to the present invention is a system capable of causing a work vehicle to automatically travel according to an instruction output from a first operation device. The automatic traveling system sets whether to include, in an automatic traveling permission condition for permitting automatic traveling, a condition in which a communication state between the first operation device and the work vehicle is a connection state where communication between the first operation device and the work vehicle is established.

### Advantageous Effects of Invention

According to the present invention, an automatic traveling method, an automatic traveling program, and an automatic traveling system, capable of improving convenience in automatic traveling of a work vehicle can be provided.

### BRIEF DESCRIPTION OF DRAWINGS

FIG. 1 is a block diagram illustrating a configuration of an automatic traveling system according to an embodiment of the present invention;

FIG. 2 is an external view illustrating an example of a work vehicle according to the embodiment of the present invention;

FIG. 3 is a diagram illustrating an example of a field and a target route according to the embodiment of the present invention;

FIG. 4 is a diagram illustrating an installation example of an operation terminal in the work vehicle according to the embodiment of the present invention;

FIG. 5 is an external view illustrating an example of a remote controller according to the embodiment of the present invention;

FIG. 6 is a diagram illustrating an example of a menu screen displayed on the operation terminal according to the embodiment of the present invention;

FIG. 7 is a diagram illustrating an example of an operation screen displayed on the operation terminal according to the embodiment of the present invention;

FIG. 8 is a diagram illustrating an example of the operation screen displayed on the operation terminal according to the embodiment of the present invention;

FIG. 9 is a diagram illustrating an example of the operation screen displayed on the operation terminal according to the embodiment of the present invention;

FIG. 10 is a diagram illustrating an example of an operation device setting screen displayed on the operation terminal according to the embodiment of the present invention;

FIG. 11 is a diagram illustrating an example of an operation screen displayed on an operation terminal according to a modification of the present invention; and

FIG. 12 is a flowchart showing an example of a procedure of an automatic traveling process executed by the automatic traveling system according to the embodiment of the present invention.

### DESCRIPTION OF EMBODIMENTS

The following embodiments are merely embodied examples of the present invention, and do not limit the technical scope of the present invention.

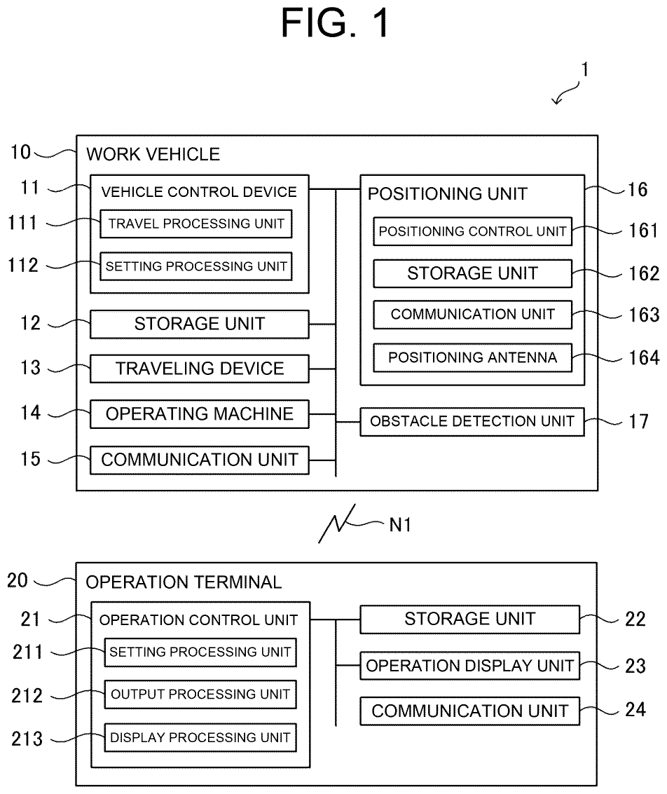

As illustrated in FIG. 1, an automatic traveling system 1 according to an embodiment of the present invention includes a work vehicle 10 and an operation terminal 20. The work vehicle 10 and the operation terminal 20 can communicate with each other via a communication network N1. For example, the work vehicle 10 and the operation terminal 20 can communicate with each other via a mobile phone network, a packet network, or a wireless LAN.

In the present embodiment, a case where the work vehicle 10 is a tractor is described as an example. As another embodiment, the work vehicle 10 may be a planting machine, a combine, a construction machine, a snow removal vehicle, or the like. The work vehicle 10 has a configuration enabling automatic traveling (autonomous traveling) in a field registered in advance. For example, an operator registers a field as a work target, and sets a travel route (target route) along which the work vehicle 10 automatically travels in the field. The work vehicle 10 automatically travels according to the target route set in advance in the field on the basis of position information on a current position of the work vehicle 10 calculated by a positioning unit 16. In addition, the work vehicle 10 performs a predetermined work while automatically traveling in the field.

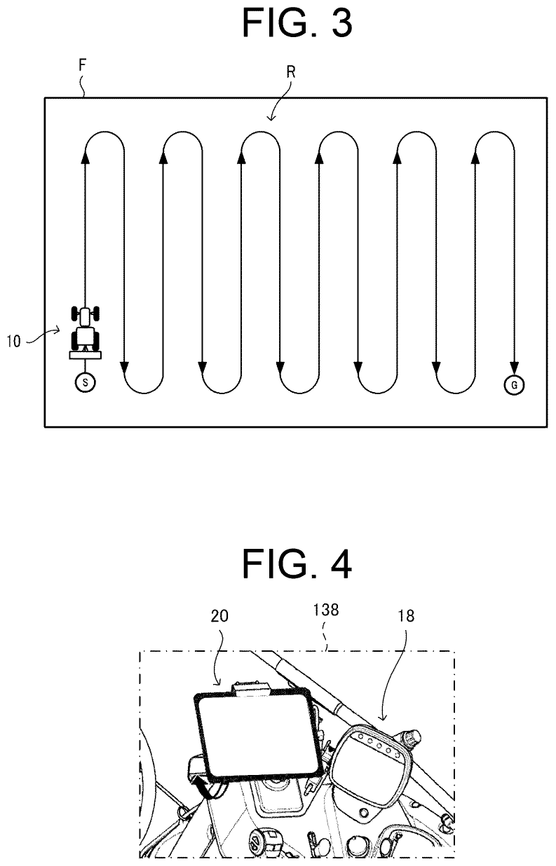

For example, the work vehicle 10 automatically travels according to a target route R in a filed F illustrated in FIG. 3. Specifically, the work vehicle 10 works while automatically traveling according to the target route R from a work start position S to a work end position G. The target route R includes a work route and a non-work route (such as a transfer route and a turning route). The target route R is not limited to the route illustrated in FIG. 3 and is appropriately set according to the work content. The work start position S and the work end position G can be set to arbitrary positions in the field F.

The operation terminal 20 is an operation device that registers the field F, sets the target route R, receives, from an operator, a start instruction and a stop instruction to start and stop automatic traveling, respectively, and displays a work status during automatic traveling. The operator can bring the operation terminal 20 into the work vehicle 10 and operate the operation terminal 20, and can operate the operation terminal 20 outside the work vehicle 10.

The communication state between the operation terminal 20 and the work vehicle 10 may become unstable depending on the usage environment. In conventional techniques, when the communication state becomes unstable, and the communication between the operation terminal 20 and the work vehicle 10 is interrupted, automatic traveling cannot be started, or automatic traveling cannot be continued. Therefore, for example, even in an environment in which automatic traveling can be started by operating an operation unit (such as an operation device 18 or a remote controller 19) provided in the work vehicle 10, when the communication between the operation terminal 20 and the work vehicle 10 is interrupted, start or continuation of automatic traveling is restricted, and a problem of deterioration of convenience in automatic traveling thus arises. In contrast, the automatic traveling system 1 according to the present embodiment can improve convenience in automatic traveling of the work vehicle 10 as described below.

### Work Vehicle 10

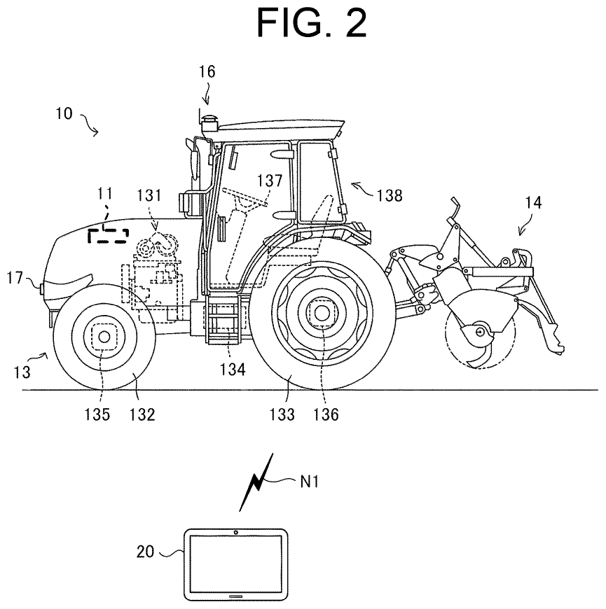

As illustrated in FIG. 1 and FIG. 2, the work vehicle 10 includes a vehicle control device 11, a storage unit 12, a traveling device 13, an operating machine 14, a communication unit 15, the positioning unit 16, an obstacle detection unit 17, and the like. The vehicle control device 11 is electrically connected to the storage unit 12, the traveling device 13, the operating machine 14, the positioning unit 16, the obstacle detection unit 17, and the like. Note that the vehicle control device 11 and the positioning unit 16 may be capable of wireless communication. In addition, the vehicle control device 11 and the obstacle detection unit 17 may be capable of wireless communication.

The communication unit 15 is a communication interface for connecting the work vehicle 10 to the communication network N1 via wired or wireless communication, and executing data communication with an external device such as the operation terminal 20 according to a predetermined communication protocol via the communication network N1. The work vehicle 10 can wirelessly communicate with the operation terminal 20 via the communication unit 15.

The traveling device 13 is a drive unit causing the work vehicle 10 to travel. As illustrated in FIG. 2, the traveling device 13 includes an engine 131, a front wheel 132, a rear wheel 133, a transmission 134, a front axle 135, a rear axle 136, a handle 137, and the like. Note that the front wheel 132 and the rear wheel 133 are provided on each of the left and right sides of the work vehicle 10. In addition, the traveling device 13 is not limited to a wheel type including the front wheel 132 and the rear wheel 133 but may also be a crawler type including a crawler provided on each of the left and right sides of the work vehicle 10.

The engine 131 is a drive source such as a diesel engine or a gasoline engine driven by using fuel supplied to a fuel tank (not shown). The traveling device 13 may include an electric motor as the drive source together with the engine 131 or instead of the engine 131. Incidentally, a generator (not shown) is connected to the engine 131, and electric power is supplied from the generator to an electric component such as the vehicle control device 11 provided in the work vehicle 10, a battery, and the like. The battery is charged by electric power supplied from the generator. Electric components such as the vehicle control device 11, the positioning unit 16, and the obstacle detection unit 17 provided in the work vehicle 10 can be then driven by electric power supplied from the battery even after the engine 131 stops.

The driving force of the engine 131 is transmitted to the front wheel 132 via the transmission 134 and the front axle 135, and is transmitted to the rear wheel 133 via the transmission 134 and the rear axle 136. The driving force of the engine 131 is also transmitted to the operating machine 14 via a PTO shaft (not shown). When the work vehicle 10 automatically travels, the traveling device 13 performs a traveling operation according to a command from the vehicle control device 11.

The operating machine 14 is, for example, a tiller, a mower, a plow, a fertilizer applicator, a sower, or a sprayer, and is attachable to and detachable from the work vehicle 10. Consequently, the work vehicle 10 can perform various kinds of work using each operating machine 14. FIG. 2 shows a case where the operating machine 14 is a tiller.

The operating machine 14 may be supported in the work vehicle 10 so as to be movable up and down by an elevating mechanism (not shown). The vehicle control device 11 can control the elevating mechanism to move the operating machine 14 up and down. For example, the vehicle control device 11 lowers the operating machine 14 when the work vehicle 10 travels straight along the work route in the forward direction, and raises the operating machine 14 when the work vehicle 10 travels while turning. In addition, the vehicle control device 11 outputs a work stop command to the operating machine 14 when the vehicle control device 11 acquires a work stop instruction. For example, the vehicle control device 11 acquires the stop instruction from the operation terminal 20 when the operator performs a stop instruction operation on the operation terminal 20. When the vehicle control device 11 acquires the work stop instruction, the vehicle control device 11 stops the drive of the PTO shaft to stop the work of the operating machine 14.

The handle 137 is an operation unit operated by the operator or the vehicle control device 11. For example, in the traveling device 13, the angle of the front wheel 132 is changed by a hydraulic power steering mechanism (not shown) or the like according to an operation of the handle 137 operated by the vehicle control device 11, and the traveling direction of the work vehicle 10 is changed. When the operator performs a teaching operation in registering the field F, the operator operates the handle 137 to manually drive the work vehicle 10. In addition, when the work vehicle 10 is moved to the work start position S, the operator operates the handle 137 to manually drive the work vehicle 10.

In addition, the traveling device 13 includes a shift lever, an accelerator, a brake, and the like (not shown) operated by the vehicle control device 11 in addition to the handle 137. In the traveling device 13, a gear of the transmission 134 is switched to a forward gear, a reverse gear, or the like according to an operation of the shift lever operated by the vehicle control device 11, and the traveling mode of the work vehicle 10 is switched between a forward movement and a reverse movement. In addition, the vehicle control device 11 operates the accelerator to control the number of revolutions of the engine 131. In addition, the vehicle control device 11 operates the brake to brake the rotation of the front wheel 132 and the rear wheel 133 using an electromagnetic brake.

The positioning unit 16 is a communication device including a positioning control unit 161, a storage unit 162, a communication unit 163, a positioning antenna 164 (see FIG. 1), and the like. For example, the positioning unit 16 is provided in an upper portion of a cabin 138 which the operator boards, as illustrated in FIG. 2. In addition, the installation position of the positioning unit 16 is not limited to the cabin 138. In addition, the positioning control unit 161, the storage unit 162, the communication unit 163, and the positioning antenna 164 of the positioning unit 16 may be dispersedly disposed in different positions in the work vehicle 10. Note that a battery is connected to the positioning unit 16, and the positioning unit 16 can run even when the engine 131 stops. In addition, a mobile phone, a smartphone, a tablet device, a quantum compass, or the like may be used instead of the positioning unit 16, for example.

The positioning control unit 161 is a computer system including one or more processors and a storage memory such as a non-volatile memory or a RAM. The storage unit 162 is a non-volatile memory or the like that stores a program for causing the positioning control unit 161 to execute a positioning process and data such as positioning information and movement information. For example, the program is recorded on a computer-readable recording medium such as a CD or a DVD in a non-transitory manner, and is read by a predetermined reading device (not shown) and stored in the storage unit 162. Note that the program may be downloaded from a server (not shown) to the positioning unit 16 via the communication network N1 and stored in the storage unit 162.

The communication unit 163 is a communication interface for connecting the positioning unit 16 to a communication network in a wired or wireless manner and executing data communication according to a predetermined communication protocol with an external device such as a base station server via the communication network.

The positioning antenna 164 is an antenna that receives radio waves (GNSS signals) transmitted from a satellite.

The positioning control unit 161 calculates the current position of the work vehicle 10 on the basis of a GNSS signal received from a satellite by the positioning antenna 164. For example, when the work vehicle 10 automatically travels in the field F, when the positioning antenna 164 receives radio waves (transmission time, trajectory information, and the like) transmitted from each of multiple satellites, the positioning control unit 161 calculates the distance between the positioning antenna 164 and each satellite, and calculates the current position (latitude and longitude) of the work vehicle 10 on the basis of the calculated distance. The positioning control unit 161 may also perform positioning by a real-time kinematic method (RTK-GNSS positioning method (RTK method)) in which the current position of the work vehicle 10 is calculated using correction information corresponding to a base station (reference station) close to the work vehicle 10. In this manner, the work vehicle 10 automatically travels using positioning information according to the RTK method. Note that the current position of the work vehicle 10 may be the same position as the positioning position (for example, the position of the positioning antenna 164) or may be a position deviated from the positioning position. The positioning control unit 161 may calculate (determine) the current position of the work vehicle 10 using a quantum compass.

The obstacle detection unit 17 is provided on a front side of the vehicle body of the work vehicle 10. The obstacle detection unit 17 is configured by a sensor that detects an obstacle in a predetermined detection area using, for example, infrared rays, ultrasonic waves, millimeter waves, or the like. For example, the obstacle detection unit 17 may be a Lidar sensor (distance sensor) capable of measuring a distance to a measurement target (obstacle) in three dimensions using a laser, or may be a sonar sensor having a plurality of sonar systems capable of measuring a distance to a measurement target using ultrasonic waves. The obstacle is, for example, a ridge, a water intake, a utility pole, a material temporarily placed in the field F, a person, or the like. Upon detecting the obstacle, the obstacle detection unit 17 transmits a detection result (measurement information) to the vehicle control device 11. When the obstacle detection unit 17 detects an obstacle in the detection area, the vehicle control device 11 causes the work vehicle 10 to emit a warning sound or decelerates or stops the work vehicle 10.

Note that the obstacle detection unit 17 may be provided on each of a front side, a rear side, a left side, and a right side. In this case, the vehicle control device 11 controls traveling of the work vehicle 10 on the basis of detection results of the respective obstacle detection units 17.

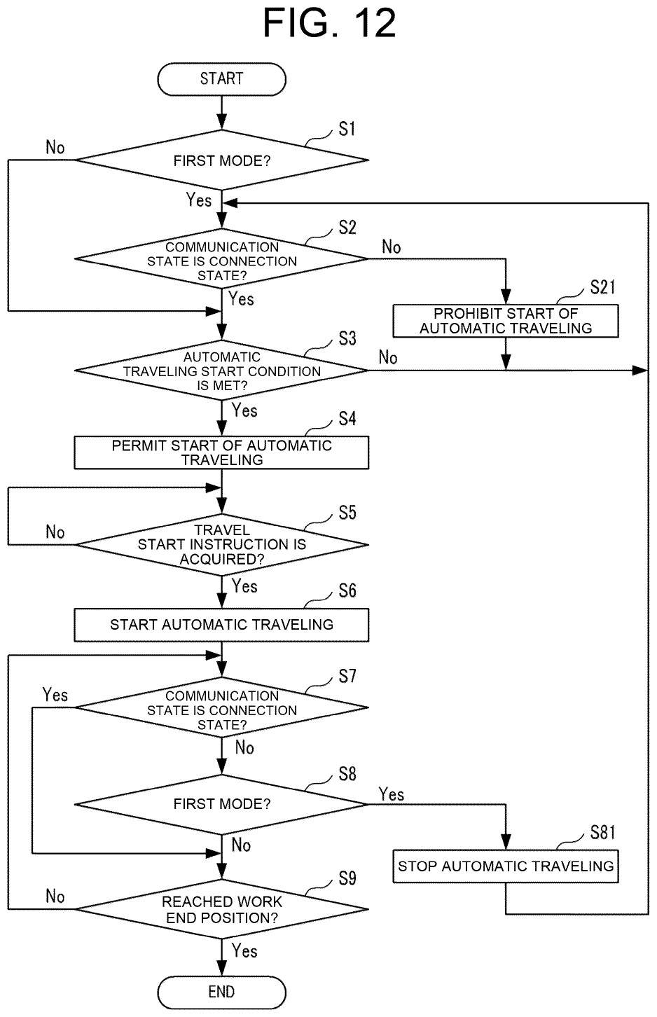

The storage unit 12 is a non-volatile storage unit such as a hard disk drive (HDD), a solid state drive (SSD), or a flash memory that stores various kinds of information. The storage unit 12 stores a control program such as an automatic traveling program for causing the vehicle control device 11 to execute an automatic traveling process (see FIG. 12). For example, the automatic traveling program is non-temporarily recorded on a computer-readable recording medium such as a flash ROM, an EEPROM, a CD, or a DVD, and is read by a predetermined reading device (not shown) and stored in the storage unit 12. Note that the automatic traveling program may be downloaded from a server (not shown) to the work vehicle 10 via the communication network N1 and stored in the storage unit 12. In addition, the storage unit 12 may store route data of the target route R generated in the operation terminal 20.

The vehicle control device 11 has control devices such as a CPU, a ROM, and a RAM. The CPU is a processor that executes various kinds of arithmetic processing. The ROM is a nonvolatile storage unit in which control programs such as a BIOS and an OS for causing the CPU to execute various kinds of arithmetic processing are stored in advance. The RAM is a volatile or non-volatile storage unit that stores various kinds of information, and is used as a temporary storage memory (work area) for various kinds of processing executed by the CPU. The vehicle control device 11 controls the work vehicle 10 by causing the CPU to execute various control programs stored in advance in the ROM or the storage unit 12.

The vehicle control device 11 controls an operation of the work vehicle 10 according to various user operations for the work vehicle 10. In addition, the vehicle control device 11 executes the automatic traveling process of the work vehicle 10 on the basis of the current position of the work vehicle 10 calculated by the positioning unit 16 and the target route R set in advance.

As illustrated in FIG. 1, the vehicle control device 11 includes various processing units such as a travel processing unit 111 and a setting processing unit 112. Note that the vehicle control device 11 functions as the various processing units by causing the CPU to execute various kinds of processing according to the automatic traveling program. In addition, some or all of the processing units may be configured by an electronic circuit. Note that the automatic traveling program may be a program for causing a plurality of processors to function as the processing unit(s).

The travel processing unit 111 controls traveling of the work vehicle 10. Specifically, the travel processing unit 111 causes the work vehicle 10 to automatically travel along the target route R (see FIG. 3) set in the field F. In addition, the travel processing unit 111 determines whether the work vehicle 10 is in a state where the work vehicle 10 can start automatic traveling. For example, the travel processing unit 111 determines whether the current position of the work vehicle 10 meets a predetermined condition (automatic traveling start condition) in relation to the work start position S set in the field F. The automatic traveling start condition includes a condition in which “the distance from the work start position S to the work vehicle 10 in the front-back direction is within X1 meters,” a condition in which “distances on the left and right sides of the work vehicle 10 from the target route R to the work vehicle 10 are both within X2 meters,” a condition in which “the angle formed by the orientation of the work vehicle 10 and the direction of the target route R is within Y1 degrees,” a condition in which “the remaining distance to a turning position on a straight path is Z1 meters or longer,” and the like. In a case where all these automatic traveling start conditions are met, the travel processing unit 111 determines that the work vehicle 10 is in a state where the work vehicle 10 can start automatic traveling, and permits start of automatic traveling. On the other hand, when any of the automatic traveling start conditions are not met, the travel processing unit 111 determines that the work vehicle 10 is not in a state where the work vehicle 10 can start automatic traveling, and prohibits start of automatic traveling.

In addition, the travel processing unit 111 determines whether a condition (automatic traveling continuation condition) for continuing automatic traveling is met while the work vehicle 10 is automatically traveling. The automatic traveling continuation condition includes a condition in which “distances on the left and right sides of the work vehicle 10 from the target route R to the work vehicle 10 are both within X3 meters,” “the angle formed by the orientation of the work vehicle 10 and the direction of the target route R is within Y2 degrees,” “positioning accuracy is a predetermined value or higher,” and the like. In a case where all these automatic traveling continuation conditions are met, the travel processing unit 111 determines that the work vehicle 10 is in a state where the work vehicle 10 can continue the automatic traveling, and continues the automatic traveling. On the other hand, when any of the automatic traveling continuation conditions are not met, the travel processing unit 111 determines that the work vehicle 10 is not in a state where the work vehicle 10 can continue the automatic traveling, and stops the automatic traveling.

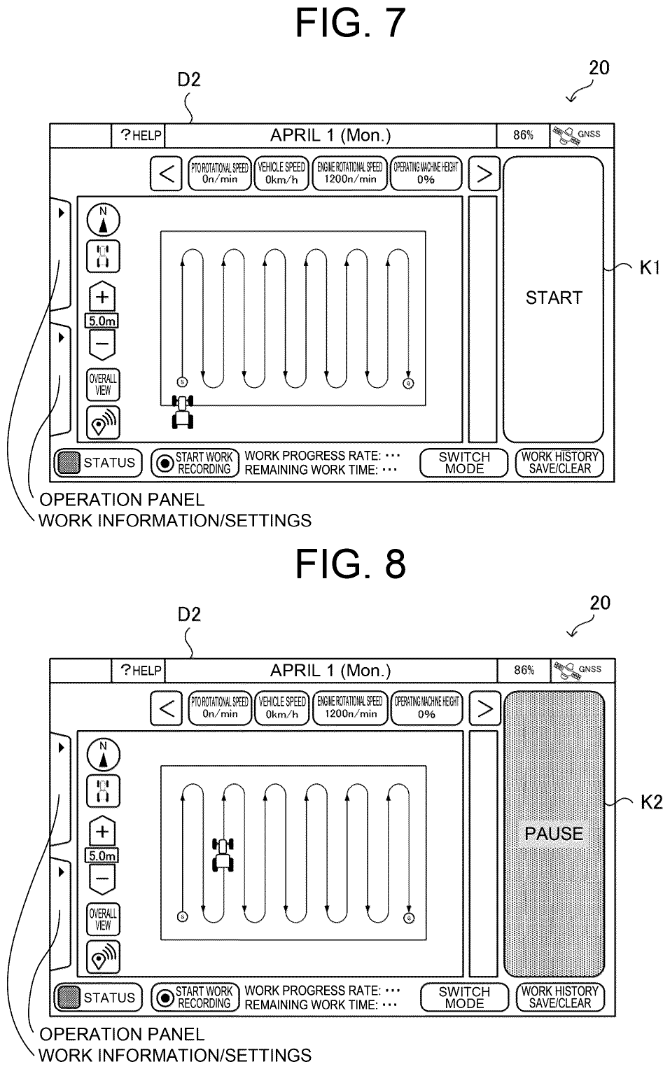

When automatic traveling of the work vehicle 10 is permitted, the travel processing unit 111 permits reception of the travel start instruction from the operation terminal 20. In this case, the operation terminal 20 displays an input button (start button K1) for the travel start instruction on an operation screen D2 (see FIG. 7), and receives the travel start instruction from the operator. When the travel start instruction is acquired from the operation terminal 20, the travel processing unit 111 starts automatic traveling of the work vehicle 10 from the work start position S. When starting the automatic traveling, the work vehicle 10 works while automatically traveling from the work start position S according to the target route R.

In addition, the travel processing unit 111 controls traveling of the work vehicle 10 on the basis of a detection result of the obstacle detection unit 17. Specifically, when the obstacle detection unit 17 detects an obstacle, the travel processing unit 111 decelerates or stops the work vehicle 10. In addition, the travel processing unit 111 may cause the work vehicle 10 to perform avoidance traveling for avoiding the obstacle.

In addition, the travel processing unit 111 stops the automatic traveling of the work vehicle 10 when a travel stop instruction is acquired from the operation terminal 20. For example, when the operator presses a pause button K2 (see FIG. 7 and FIG. 8) on the operation screen D2 of the operation terminal 20, the operation terminal 20 outputs the travel stop instruction to the work vehicle 10.

In the present embodiment, it is possible to set whether to include, in the automatic traveling permission condition for permitting automatic traveling, a condition related to the communication state between the work vehicle 10 and the operation terminal 20.

Specifically, the setting processing unit 112 sets whether to include, in the automatic traveling permission condition for permitting automatic traveling, a condition in which “the communication state between the operation terminal 20 and the work vehicle 10 is a connection state where communication between the operation terminal 20 and the work vehicle 10 is established.” For example, the setting processing unit 112 has a first mode in which the condition in which “the communication state between the operation terminal 20 and the work vehicle 10 is the connection state” is included in the automatic traveling permission condition and a second mode in which “the communication state between the operation terminal 20 and the work vehicle 10 is the connection state” is not included in the automatic traveling permission condition, and sets the first mode or the second mode. In addition, the setting processing unit 112 can alternatively switch the first mode and the second mode. Note that the automatic traveling permission condition includes at least one of the automatic traveling start condition and the automatic traveling continuation condition.

Specific examples of a method of setting the automatic traveling permission condition related to the communication state between the operation terminal 20 and the work vehicle 10 will be described later.

### Operation Terminal 20

As illustrated in FIG. 1, the operation terminal 20 is an information processing device including an operation control unit 21, a storage unit 22, an operation display unit 23, a communication unit 24, and the like. The operation terminal 20 may be configured by a mobile terminal such as a tablet device or a smartphone.

The communication unit 24 is a communication interface for connecting the operation terminal 20 to the communication network N1 in a wired or wireless manner and executing data communication according to a predetermined communication protocol with an external device such as one or more work vehicles 10 via the communication network N1.

The operation display unit 23 is a user interface including: a display unit that displays various kinds of information, such as a liquid crystal display or an organic EL display; and an operation unit that receives an operation, such as a touch panel, a mouse, or a keyboard. The operator can perform an operation to register various kinds of information (work vehicle information, field information, work information, and the like described later) by operating the operation unit on an operation screen displayed on the display unit. For example, the operator performs an operation to register the field F as a work target with the operation unit.

In addition, the operator can provide the travel start instruction, the travel stop instruction, and the like to the work vehicle 10 by operating the operation unit. Further, at a location away from the work vehicle 10, the operator can grasp, through a traveling trajectory displayed on the operation terminal 20, a traveling state of the work vehicle 10 being automatically traveling along the target route R in the field F.

The storage unit 22 is a non-volatile storage unit such as a HDD, an SSD, or a flash memory that stores various kinds of information. The storage unit 22 stores a control program for causing the operation control unit 21 to execute a predetermined process. For example, the control program is non-temporarily recorded on a computer-readable recording medium such as a flash ROM, an EEPROM, a CD, or a DVD, and is read by a predetermined reading device (not shown) and stored in the storage unit 22. The control program may be downloaded from a server (not shown) to the operation terminal 20 via the communication network N1 and stored in the storage unit 22.

In addition, a dedicated application for causing the work vehicle 10 to automatically travel is installed in the storage unit 22. The operation control unit 21 launches the dedicated application to perform a process of setting various kinds of information related to the work vehicle 10, a process of generating the target route R for the work vehicle 10, and a process of issuing an automatic traveling instruction to the work vehicle 10.

In addition, the storage unit 22 stores data such as work vehicle information, which is information on the work vehicle 10, target route information, which is information on the target route R, and the like. The work vehicle information includes information on a vehicle number, a model type, and the like for each work vehicle 10. The vehicle number is identification information on the work vehicle 10. The model type is a model type of the work vehicle 10.

In addition, the storage unit 22 may store the work vehicle information on one work vehicle 10 or may store the work vehicle information on a plurality of work vehicles 10. For example, when a certain operator owns a plurality of work vehicles 10, the work vehicle information on each work vehicle 10 is stored in the storage unit 22.

The target route information includes information such as a route name, a field name, an address, a field area, and a work time for each target route R. The route name is a route name of the target route R generated in the operation terminal 20. The field name is the name of the field F as a work target for which the target route R is set. The address is the address of the field F, and the field area is the area of the field F. The work time is a time required for the work vehicle 10 to work the field F.

In addition, the storage unit 22 may store the target route information on one target route R or may store the target route information on a plurality of target routes R. For example, when a certain operator generates a plurality of target routes R for one or more fields F owned by the certain operator, the target route information on each target route R is stored in the storage unit 22. Note that one target route R may be set or a plurality of target routes R may be set for one field F.

Note that as another embodiment, information such as the work vehicle information and the target route information may be partially or entirely stored in a server accessible from the operation terminal 20. The operator may perform an operation to register the work vehicle information and the target route information on the server (for example, a personal computer, a crowd server, or the like).

The operation control unit 21 has control devices such as a CPU, a ROM, and a RAM. The CPU is a processor that executes various kinds of arithmetic processing. The ROM is a nonvolatile storage unit in which control programs such as a BIOS and an OS for causing the CPU to execute various kinds of arithmetic processing are stored in advance. The RAM is a volatile or non-volatile storage unit that stores various kinds of information, and is used as a temporary storage memory for various kinds of processing executed by the CPU. The operation control unit 21 controls the operation terminal 20 by causing the CPU to execute various control programs stored in advance in the ROM or the storage unit 22.

As illustrated in FIG. 1, the operation control unit 21 includes various processing units such as a setting processing unit 211, an output processing unit 212, and a display processing unit 213. The operation control unit 21 functions as the various processing units by causing the CPU to execute various kinds of processing according to the control program. In addition, some or all of the processing units may be configured by an electronic circuit. Note that the control program may be a program for causing a plurality of processors to function as the processing unit(s).

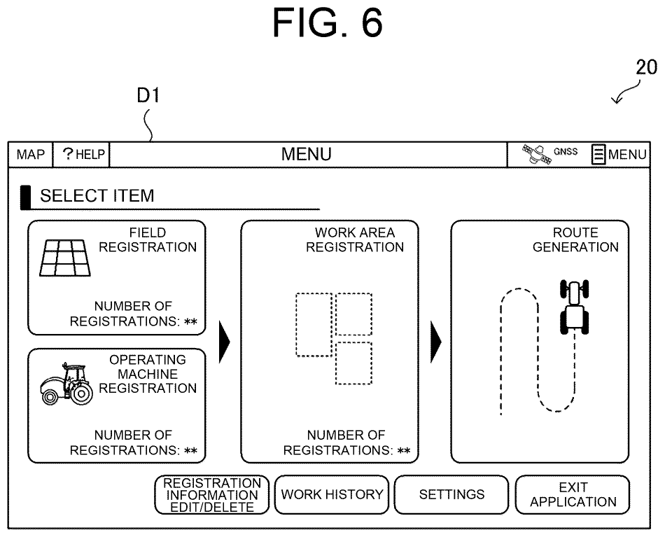

The setting processing unit 211 sets information (hereinafter, referred to as work vehicle information) on the work vehicle 10, information (hereinafter, referred to as field information) on the field F, and information (hereinafter, referred to as work information) on how to specifically work. The setting processing unit 211 receives a setting operation performed by the operator on a menu screen D1 illustrated in FIG. 6 and registers each piece of setting information, for example.

Specifically, the setting processing unit 211 sets information such as a model of the work vehicle 10, a position at which the positioning antenna 164 is attached in the work vehicle 10, a type of the operating machine 14, a size and shape of the operating machine 14, a position of the operating machine 14 with respect to the work vehicle 10, a traveling speed and the number of revolutions of the engine during work performed by the work vehicle 10, and a traveling speed and the number of revolutions of the engine during turning of the work vehicle 10, by the operator performing an operation to register the information on the operation terminal 20.

In addition, the setting processing unit 211 sets information such as a position and shape of the field F, the work start position S and the work end position G, and a work direction by performing an operation to register the information on the operation terminal 20.

The information on the position and shape of the field F can be automatically acquired by, for example, the operator boarding the work vehicle 10, driving the work vehicle 10 around the perimeter of the field F once along the outer periphery of the field F, and recording the transition of the position information from the positioning antenna 164 at that time. In addition, the position and shape of the field F can also be acquired on the basis of a polygon obtained by the operator operating the operation terminal 20 to designate a plurality of points on a map in a state where the map is displayed on the operation terminal 20. The region specified by the acquired position and shape of the field F is a region (traveling region) in which the work vehicle 10 can travel.

The setting processing unit 211 is configured to be capable of setting, as the work information, the presence or absence of cooperative work of a plurality of work vehicles 10, a skip count, which is the number of work routes to be skipped when the work vehicle 10 turns in a headland, a width of the headland, a width of a non-cultivated land, and the like.

For example, the setting processing unit 211 sets a work area in which work is actually performed in the registered field F. For example, when the operator selects the “work area registration” on the menu screen D1 (see FIG. 6) and selects the field F for which the work area is to be registered, the setting processing unit 211 displays a registration screen (map screen) on which the work start position S and the work end position G are registered. The operator registers the work start position S and the work end position G at arbitrary positions in the field F on the registration screen. For example, the operator registers the work start position S and the work end position G in the vicinity of an entrance or a ridge of the field F (see FIG. 3).

In addition, the setting processing unit 211 generates the target route R along which the work vehicle 10 automatically travels in the field F on the basis of each piece of the setting information. For example, when the operator selects “route generation” on the menu screen D1 (see FIG. 6), the setting processing unit 211 displays a registration screen for generating a route. On the registration screen, the operator registers pieces of information on the field F, the operating machine 14, a turning method, a headland, a vehicle speed, the number of revolutions of the engine, and the like and then provides a route generation instruction. Upon acquiring the route generation instruction, the setting processing unit 211 generates the target route R on the basis of the work start position S, the work end position G, and each piece of the above-described information. The setting processing unit 211 registers the generated target route R in association with the field F.

The output processing unit 212 outputs the route data on the target route R to the work vehicle 10. For example, when the operator selects the field F as a work target and the work route (target route R) and performs a work start operation, the route data on the target route R corresponding to the field F is output to the work vehicle 10.

Upon receiving the route data on the target route R generated by the operation terminal 20, the work vehicle 10 stores the route data in the storage unit 12.

The display processing unit 213 causes the operation display unit 23 to display various operation screens. For example, the display processing unit 213 displays the menu screen D1 (see FIG. 6), the operation screen D2 (see FIG. 7, etc.), and the like.

As described above, when the automatic traveling start condition is met, the work vehicle 10 starts automatic traveling in response to the travel start instruction from the operator via the operation terminal 20. While the work vehicle 10 is automatically traveling, the operator can grasp the traveling state in the field F with the operation terminal 20.

Note that the operation terminal 20 may be capable of accessing an agriculture support service website (agriculture support site) provided by a server (not shown) via the communication network N1. In this case, the operation terminal 20 can function as a terminal for operating the server by the browser program executed by the operation control unit 21. The server includes the above-described processing units and executes each process.

Next, specific examples (Examples 1 to 4) of the method of setting the automatic traveling permission condition related to the communication state between the work vehicle 10 and the operation terminal 20 will be described.

### Example 1

In Example 1, the setting processing unit 112 of the work vehicle 10 sets whether to include, in the automatic traveling permission condition, the condition in which “the communication state between the operation terminal 20 and the work vehicle 10 is the connection state” on the basis of the position of the operation terminal 20. Specifically, the setting processing unit 112 configures a setting (setting in a first mode) to include, in the automatic traveling permission condition, the condition in which “the communication state between the operation terminal 20 and the work vehicle 10 is the connection state,” when the operation terminal 20 is located inside the work vehicle 10, and configures a setting (setting in a second mode) not to include, in the automatic traveling permission condition, the condition in which “the communication state between the operation terminal 20 and the work vehicle 10 is the connection state,” when the operation terminal 20 is located outside the work vehicle 10.

For example, the operator boards the work vehicle 10 with the operation terminal 20 when starting automatic traveling of the work vehicle 10. The operator sets the operation terminal 20 at a predetermined position in the cabin 138 (see FIG. 4). When the operation terminal 20 is in the work vehicle 10, since the communication state between the operation terminal 20 and the work vehicle 10 is relatively stable, the communication state between the operation terminal 20 and the work vehicle 10 is easily maintained in the connection state. Therefore, for example, even if the condition in which “the communication state between the operation terminal 20 and the work vehicle 10 is the connection state” is included in the automatic traveling permission condition, automatic traveling is not hindered from being permitted. That is, in a case where the condition in which “the communication state between the operation terminal 20 and the work vehicle 10 is the connection state” is included in the automatic traveling permission condition, automatic traveling is neither hindered from starting due to nonfulfillment of the automatic traveling start condition nor easily stopped due to nonfulfillment of the automatic traveling continuation condition. In addition, when the condition in which “the communication state between the operation terminal 20 and the work vehicle 10 is the connection state” is included in the automatic traveling permission condition, it is possible to ensure that the operator is in a state where the operator can confirm the status of the work vehicle 10 on the operation terminal 20 when starting automatic traveling and during automatic traveling, and it is thus possible to improve safety and reliability.

On the other hand, when the operator operates the operation terminal 20 outside the work vehicle 10, for example, the communication state between the operation terminal 20 and the work vehicle 10 may become unstable or may be blocked. In this case, when the condition in which “the communication state between the operation terminal 20 and the work vehicle 10 is the connection state” is included in the automatic traveling permission condition, the automatic traveling start condition is not met, and it becomes difficult to start automatic traveling, or the automatic traveling continuation condition is not met, and it becomes easy to stop automatic traveling. As described above, when the automatic traveling permission condition becomes strict, convenience in automatic traveling may be deteriorated. In particular, in an environment in which another operator different from the operator outside the vehicle who operates the operation terminal 20 boards the work vehicle 10, convenience may be significantly deteriorated, for example, start and continuation of automatic traveling are prohibited even though said another operator can carry out the operation and monitoring inside the vehicle.

Therefore, when the operation terminal 20 is located outside the work vehicle 10, the setting processing unit 112 configures the setting not to include, in the automatic traveling permission condition, the condition in which “the communication state between the operation terminal 20 and the work vehicle 10 is the connection state.”

As described above, in Example 1, the setting processing unit 112 configures the setting (first mode) to include, in the automatic traveling permission condition, the condition in which “the communication state between the operation terminal 20 and the work vehicle 10 is the connection state,” when the operation terminal 20 is located inside the work vehicle 10; meanwhile, the setting processing unit 112 configures the setting (second mode) not to include, in the automatic traveling permission condition, the condition in which “the communication state between the operation terminal 20 and the work vehicle 10 is the connection state,” when the operation terminal 20 is located outside the work vehicle 10.

Note that the setting processing unit 112 determines the position of the operation terminal 20 (whether the operation terminal 20 is inside or outside the work vehicle 10) by a predetermined method. For example, the setting processing unit 112 determines the position of the operation terminal 20 by a detection unit (a switch, a sensor, or the like) provided at an installation position (see FIG. 4) in the cabin 138. In addition, the setting processing unit 112 may determine whether the operator boards by a seat switch provided to a driver seat in the cabin 138, and may determine that the operation terminal 20 is inside the vehicle when the operator boards. In addition, the setting processing unit 112 may determine the position of the operation terminal 20 using wireless communication such as NFC.

The travel processing unit 111 controls automatic traveling of the work vehicle 10 on the basis of the setting content of the automatic traveling permission condition set by the setting processing unit 112. Specifically, when the setting processing unit 112 configures the setting (first mode) to include, in the automatic traveling permission condition, the condition in which “the communication state between the operation terminal 20 and the work vehicle 10 is the connection state,” the travel processing unit 111 prohibits start of automatic traveling when the communication state is a disconnection state. In addition, in a case where the setting processing unit 112 configures the setting in the first mode, when the communication state changes from the connection state to the disconnection state while the work vehicle 10 is automatically traveling, the automatic traveling of the work vehicle 10 is stopped. Since it is easy to maintain the communication state in the connection state when the operation terminal 20 is located inside the vehicle, start and continuation of automatic traveling are hardly restricted even when the above-described condition is included in the automatic traveling permission condition. On the other hand, when the communication state is put into the disconnection state, start and continuation of automatic traveling are restricted. Therefore, safety can be ensured while preventing a decrease in work efficiency.

On the other hand, in a case where the setting processing unit 112 configures the setting (second mode) not to include, in the automatic traveling permission condition, the condition in which “the communication state between the operation terminal 20 and the work vehicle 10 is the connection state,” the travel processing unit 111 permits start of automatic traveling in each of the case where the communication state is the connection state and the case where the communication state is the disconnection state. In addition, in a case where the setting processing unit 112 configures the setting in the second mode, when the communication state is changed from the connection state to the disconnection state while the work vehicle 10 is automatically traveling, the automatic traveling of the work vehicle 10 is continued. Consequently, since it is possible to start and continue automatic traveling regardless of the communication state between the operation terminal 20 and the work vehicle 10, it is possible to increase the work efficiency.

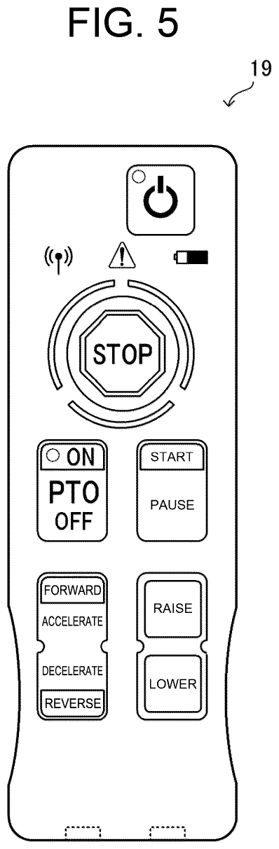

Note that the condition for permitting the setting in the second mode may be a condition in which an operation device (a second operation device of the present invention) capable of causing the work vehicle 10 to automatically travel is included in addition to the operation terminal 20. The operation device may be an operation device 18 (see FIG. 4) provided in the cabin 138, or may be a remote controller 19 (see FIG. 5) capable of communicating with the work vehicle 10. Each of the operation device 18 and the remote controller 19 includes at least a start button and a stop button for automatic traveling.

For example, the setting processing unit 112 permits the setting (second mode) not to include, in the automatic traveling permission condition, the condition in which “the communication state between the operation terminal 20 and the work vehicle 10 is the connection state” when the communication state between the operation device and the work vehicle 10 is the connection state, and prohibits the setting (second mode) not to include, in the automatic traveling permission condition, the condition in which “the communication state between the operation terminal 20 and the work vehicle 10 is the connection state” when the communication state between the operation device and the work vehicle 10 is the disconnection state. That is, the setting in the second mode is permitted on condition that the operator is in a state where automatic traveling can be controlled by the operation device. Consequently, since the setting in the second mode is permitted only when an instruction to start automatic traveling can be given by the operation device, safety of automatic traveling can be enhanced.

As another embodiment of Example 1, the setting processing unit 112 may configure the setting (second mode) not to include, in the automatic traveling permission condition, the condition in which “the communication state between the operation terminal 20 and the work vehicle 10 is the connection state” when the operation terminal 20 is located inside the work vehicle 10, and configure the setting (first mode) to include, in the automatic traveling permission condition, the condition in which “the communication state between the operation terminal 20 and the work vehicle 10 is the connection state” when the operation terminal 20 is located outside the work vehicle 10.

For example, since the operator can provide an automatic traveling instruction with another operation device (the operation device 18 or the remote controller 19) different from the operation terminal 20 when the operation terminal 20 is located inside the work vehicle 10, work efficiency can be enhanced by permitting start and continuation of automatic traveling regardless of the communication state between the operation terminal 20 and the work vehicle 10. In addition, in a case where the operation terminal 20 is located outside the work vehicle 10, since the status of the work vehicle 10 cannot be grasped by the operation terminal 20 when communication between the operation terminal 20 and the work vehicle 10 is interrupted, for example, safety can be ensured by prohibiting start and continuation of automatic traveling.

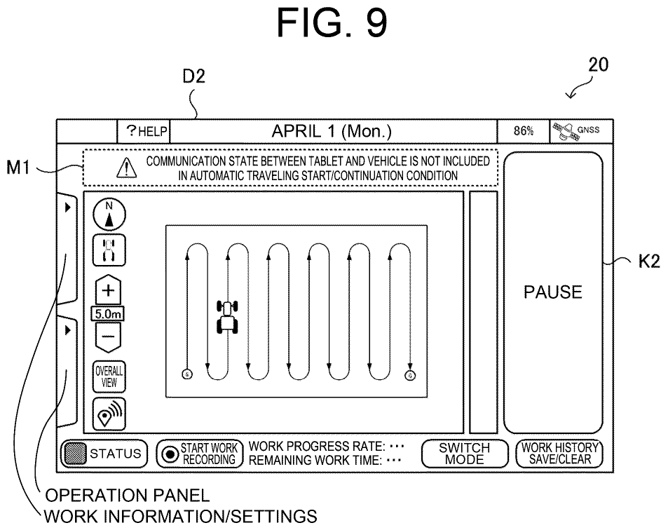

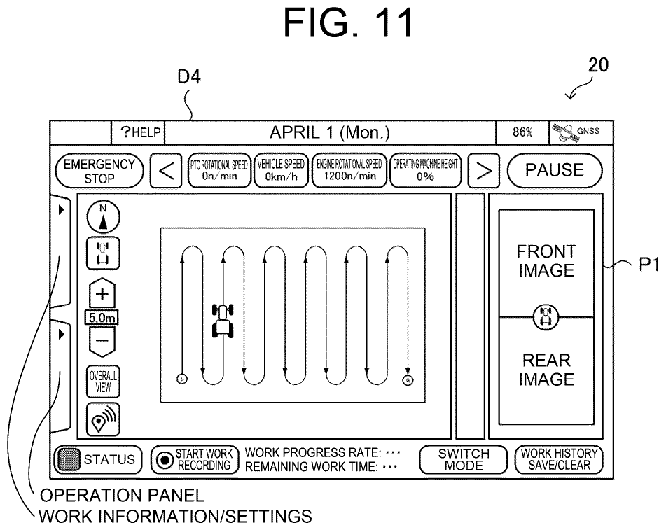

In Example 1, the display processing unit 213 of the operation terminal 20 causes the operation display unit 23 to display information enabling identification of whether the condition in which “the communication state between the operation terminal 20 and the work vehicle 10 is the connection state” is included in the automatic traveling permission condition. That is, the display processing unit 213 displays, on an operation screen of the operation terminal 20, information enabling the operator to identify which of the first mode or the second mode is set. For example, when the setting (first mode) to include, in the automatic traveling permission condition, the condition in which “the communication state between the operation terminal 20 and the work vehicle 10 is the connection state” is configured, the display processing unit 213 displays the start button K1 and the pause button K2 in a normal mode (see FIG. 7). On the other hand, when the setting (second mode) not to include, in the automatic traveling permission condition, the condition in which “the communication state between the operation terminal 20 and the work vehicle 10 is the connection state” is configured, the display processing unit 213 displays the start button K1 and the pause button K2 in a grayout state (see FIG. 8). In addition, instead of the display mode of FIG. 8, the display processing unit 213 may display a message M1 indicating that the above-described condition is not included in the automatic traveling permission condition as illustrated in FIG. 9. In addition, instead of the display mode of FIG. 8, the display processing unit 213 may render the start button K1 and the pause button K2 invisible. That is, the display processing unit 213 may be configured such that the start button K1 and the pause button K2 are displayed when the setting in the first mode is configured, and the start button K1 and the pause button K2 are not displayed when the setting in the second mode is configured. Note that when the start button K1 and the pause button K2 are made invisible, the display processing unit 213 may display, in a region for displaying the start button K1 and the pause button K2, a message M1 or a camera image P1 around the work vehicle 10 (see FIG. 11).

Note that in the second mode (see FIG. 8 and FIG. 9), the operation terminal 20 may be capable of receiving, from the operator, an operation of an automatic traveling start instruction and an automatic traveling pause instruction. That is, even when the condition described above is not included in the automatic traveling permission condition, the operator may be capable of performing an automatic traveling start operation and an automatic traveling stop operation with the operation terminal 20. In addition, in a case where the setting in which the start button K1 and the pause button K2 are made invisible is configured in the second mode, when the operator performs an operation (such as a screen touch operation) on the operation terminal 20, the start button K1 and the pause button K2 are displayed to enable reception, from the operator, of the operation of the automatic traveling start instruction and the automatic traveling pause instruction.

As another embodiment of Example 1, the setting processing unit 112 may set whether to include, in the automatic traveling permission condition, the condition in which “the communication state between the operation terminal 20 and the work vehicle 10 is the connection state,” on the basis of whether the operation terminal 20 is located within a range less than a predetermined distance from the work vehicle 10. Specifically the setting processing unit 112 configures the setting (setting in the first mode) to include, in the automatic traveling permission condition, the condition in which “the communication state between the operation terminal 20 and the work vehicle 10 is the connection state” when the operation terminal 20 is located within a range less than the predetermined distance from the work vehicle 10, and configures the setting (setting in the second mode) not to include, in the automatic traveling permission condition, the condition in which “the communication state between the operation terminal 20 and the work vehicle 10 is the connection state” when the operation terminal 20 is located within a range at least the predetermined distance away from the work vehicle 10. Note that, as another embodiment, the setting processing unit 112 may configure the setting in the second mode when the operation terminal 20 is located within a rage less than the predetermined distance from the work vehicle 10, and may configure the setting in the first mode when the operation terminal 20 is located within a range at least the predetermined distance away from the work vehicle 10. The predetermined distance is a distance around the work vehicle 10 with, for example, a radius of 1 to 5 m from the vehicle center of the work vehicle 10, preferably a radius of 3 m from the vehicle center. Note that the “inside” of the work vehicle 10 is an example of the range less than the predetermined distance.

### Example 2

In Example 2, the setting processing unit 112 sets whether to include, in the automatic traveling permission condition, the condition in which “the communication state between the operation terminal 20 and the work vehicle 10 is the connection state” according to a setting operation by the operator. Specifically, the setting processing unit 112 configures the setting in the first mode when the operator selects a mode (first mode) to include, in the automatic traveling permission condition, the condition in which “the communication state between the operation terminal 20 and the work vehicle 10 is the connection state,” and configures the setting in the second mode when the operator selects a mode (second mode) not to include, in the automatic traveling permission condition, the condition in which “the communication state between the operation terminal 20 and the work vehicle 10 is the connection state.”

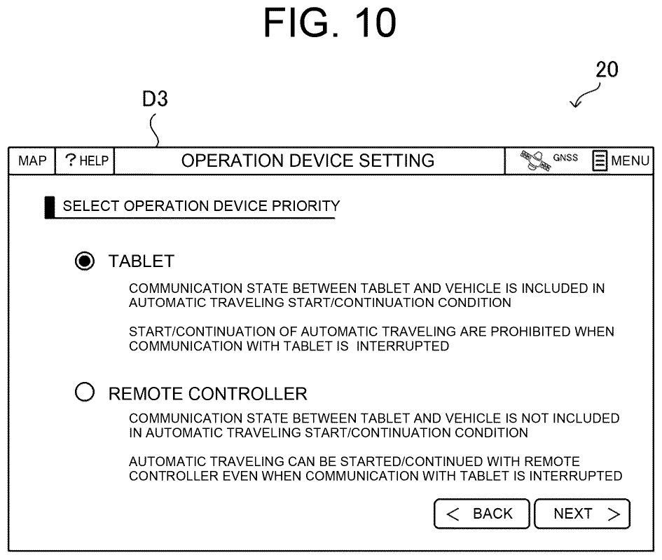

For example, the operator selects, on an operation device setting screen D3 (refer to FIG. 10) displayed on the operation terminal 20, either a “tablet” (corresponding to the operation terminal 20) or a “remote controller” (corresponding to the remote controller 19) as the operation device that is given priority in receiving a travel instruction operation. When the operator selects the “tablet,” the setting processing unit 112 configures the setting (first mode) to include, in the automatic traveling permission condition, the condition in which “the communication state between the operation terminal 20 and the work vehicle 10 is the connection state.” In this case, the travel processing unit 111 prohibits start of automatic traveling when the communication state between the operation terminal 20 and the work vehicle 10 is the disconnection state, and stops the automatic traveling of the work vehicle 10 when the communication state changes from the connection state to the disconnection state while the work vehicle 10 is automatically traveling.

On the other hand, when the operator selects the “remote controller,” the setting processing unit 112 configures the setting (second mode) not to include, in the automatic traveling permission condition, the condition in which “the communication state between the operation terminal 20 and the work vehicle 10 is the connection state.” In this case, the travel processing unit 111 permits start of automatic traveling with the remote controller 19 even when the communication state between the operation terminal 20 and the work vehicle 10 is the disconnection state, and continues the automatic traveling of the work vehicle 10 even when the communication state changes from the connection state to the disconnection state while the work vehicle 10 is automatically traveling.

The operator selects, on the operation device setting screen D3, the operation device before automatic traveling is started, for example, when each piece of the setting information is registered. Incidentally, it may be possible to select an “in-vehicle device” (corresponding to the operation device 18, for example) on the operation device setting screen D3.

### Example 3

In Example 3, the setting processing unit 112 sets whether to include, in the automatic traveling permission condition, the condition in which “the communication state between the operation terminal 20 and the work vehicle 10 is the connection state” on the basis of whether an operator boards the work vehicle 10. Specifically, the setting processing unit 112 configures the setting (setting in the first mode) to include, in the automatic traveling permission condition, the condition in which “the communication state between the operation terminal 20 and the work vehicle 10 is the connection state” when the operator boards the work vehicle 10, and configures the setting (setting in the second mode) not to include, in the automatic traveling permission condition, the condition in which “the communication state between the operation terminal 20 and the work vehicle 10 is the connection state” when the operator does not board the work vehicle 10.

In a case where the operator does not board the work vehicle 10, when the communication state between the operation terminal 20 and the work vehicle 10 is the disconnection state, operation is disabled both on the operation terminal 20 and inside the work vehicle 10. Therefore, in order to ensure safety, the setting in the first mode is configured when the operator does not board the work vehicle 10. On the other hand, in a case where the operator boards the work vehicle 10, the operator can perform operation inside the work vehicle 10 even when the communication state between the operation terminal 20 and the work vehicle 10 is the disconnection state. Therefore, in order to prevent a decrease in work efficiency, the setting in the second mode is configured when the operator boards the work vehicle 10.

As another embodiment of Example 3, the setting processing unit 112 may set whether to include, in the automatic traveling permission condition, the condition in which “the communication state between the operation terminal 20 and the work vehicle 10 is the connection state” on the basis of whether the operator is located within a range less than a predetermined distance from the work vehicle 10. Specifically, the setting processing unit 112 configures the setting (setting in the first mode) to include, in the automatic traveling permission condition, the condition in which “the communication state between the operation terminal 20 and the work vehicle 10 is the connection state” when the operator is located within a range away from the predetermined distance from the work vehicle 10, and configures the setting (setting in the second mode) not to include, in the automatic traveling permission condition, the condition in which “the communication state between the operation terminal 20 and the work vehicle 10 is the connection state” when the operator is located within a range less than the predetermined distance from the work vehicle 10.

### Example 4

In Examples 1 and 2 described above, when the automatic traveling mode is in an “unmanned mode,” the setting processing unit 112 may make the automatic traveling permission condition strict. Specifically, in the unmanned mode, when the setting (second mode) not to include, in the automatic traveling permission condition, the condition in which “the communication state between the operation terminal 20 and the work vehicle 10 is the connection state” is configured, the setting processing unit 112 permits start and continuation of automatic traveling on condition that a monitoring function is enabled.

Specifically, in the unmanned mode, the operation terminal 20 displays the operation screen D4 illustrated in FIG. 11, and displays the camera image P1 around the work vehicle 10 on the operation screen D4. When the setting processing unit 112 detects the operator visually checking the camera image P1 or receives an input operation (such as an operation of touching the camera image P1) indicating that the operator visually checks the camera image P1, the setting processing unit 112 permits start and continuation of automatic traveling. In addition, when the setting processing unit 112 does not detect the operator visually checking the camera image P1 or does not receive an input operation (such as an operation of touching the camera image P1) indicating that the operator visually checks the camera image P1, the setting processing unit 112 prohibits start and continuation of automatic traveling.

In addition, when the setting processing unit 112 determines that the camera image P1 is normally displayed on the operation terminal 20, and neither a person nor an obstacle is displayed in the camera image P1, the setting processing unit 112 may permit start and continuation of automatic traveling.

In addition, in a case where a person or an obstacle is displayed in the camera image P1, the setting processing unit 112 may permit start and continuation of automatic traveling, when an input operation indicating that the operator visually checks the person or the obstacle is received through an action of touching a corresponding position on the camera image P1.

In this manner, since no operation is performed inside the work vehicle 10 in the unmanned mode, the setting processing unit 112 makes the automatic traveling permission condition in the second mode strict. When the operation terminal 20 is in the connection state, the setting processing unit 112 permits start and continuation of automatic traveling on condition that the operator visually checks the camera image P1.

Note that when the communication state between the operation terminal 20 and the work vehicle 10 is put into the disconnection state while the work vehicle 10 is automatically traveling in the unmanned mode, for example, the travel processing unit 111 may continue the automatic traveling of the work vehicle 10. In this case, however, when the disconnection state continues for a predetermined period, the travel processing unit 111 may stop the automatic traveling of the work vehicle 10. In addition, when the communication state is put into the disconnection state while the work vehicle 10 is automatically traveling along a work route, for example, the travel processing unit 111 may continue the automatic traveling of the work vehicle 10, and may stop the automatic traveling of the work vehicle 10 when the communication state does not return to the connection state at the end of the work route.

In each of Examples 2 to 4, the same display processing as in Example 1 (see FIG. 7 to FIG. 9) may be executed.

### Automatic Traveling Process

An example of the automatic traveling process executed by the automatic traveling system 1 will be described with reference to FIG. 12.

Note that the present invention can be interpreted as an invention of an automatic traveling method executing one or more steps involved in the automatic traveling process. In addition, one or more steps involved in the automatic traveling process described herein may be appropriately omitted. Note that the execution order of steps in the automatic traveling process may vary as long as the same operation and effect are achieved. Furthermore, although a case where the vehicle control device 11 executes each step in the automatic traveling process is described here as an example, an automatic traveling method in which one or more processors execute steps in the automatic traveling process in a distributed manner is also considered as another embodiment.

### Step S1

In Step S1, the vehicle control device 11 determines, with respect to the automatic traveling permission condition, whether the setting to include, in the automatic traveling permission condition, the condition in which “the communication state between the operation terminal 20 and the work vehicle 10 is the connection state” is configured, that is, whether the setting in the first mode is configured. The vehicle control device 11 shifts the process to Step S2 when the setting in the first mode is configured (S1: Yes), and shifts the process to Step S3 when the setting in the second mode is configured (S1: No).

As described in Example 1 above, for example, the vehicle control device 11 configures the setting in the first mode when the operation terminal 20 is located inside the work vehicle 10, and configures the setting in the second mode when the operation terminal 20 is located outside the work vehicle 10. In addition, as described in Example 2 above, the vehicle control device 11 configures the setting in the first mode when the operator selects the “tablet” and configures the setting in the second mode when the operator selects the “remote controller” on the operation device setting screen D3 (see FIG. 10). In addition, as described in Example 3 above, the vehicle control device 11 configures the setting in the first mode when the operator does not board the work vehicle 10 and configures the setting in the second mode when the operator boards the work vehicle 10. Note that the vehicle control device 11 may configures the setting in the first mode and the setting in the second mode in an opposite manner in Examples 1 to 3 described above.

In addition, the vehicle control device 11 may configure a setting to include, in the automatic traveling start condition, the condition in which “the communication state between the operation terminal 20 and the work vehicle 10 is the connection state,” and configure a setting not to include, in the automatic traveling continuation condition, the condition in which “the communication state between the operation terminal 20 and the work vehicle 10 is the connection state.” In addition, the vehicle control device 11 may configure a setting not to include, in the automatic traveling start condition, the condition in which “the communication state between the operation terminal 20 and the work vehicle 10 is the connection state,” and configure a setting to include, in the automatic traveling continuation condition, the condition in which “the communication state between the operation terminal 20 and the work vehicle 10 is the connection state.” For example, the operator may be capable of independently selecting whether to include the condition in which “the communication state between the operation terminal 20 and the work vehicle 10 is the connection state” in each of the automatic traveling start condition and the automatic traveling continuation condition. Consequently, since the automatic traveling start condition and the automatic traveling continuation condition can be separately set, convenience in automatic traveling can be further improved.

### Step S2

In Step S2, the vehicle control device 11 determines whether the communication state between the operation terminal 20 and the work vehicle 10 is the connection state. The vehicle control device 11 shifts the process to Step S3 when it is determined that the communication state is the connection state (S2: Yes). On the other hand, the vehicle control device 11 shifts the process to Step S21 when it is determined that the communication state is the disconnection state (S2: No). Note that the “disconnection state” is not limited to an interrupted state and may include a state where the communication state is unstable (for example, a state where radio signal intensity is lower than a predetermined value).

### Step S3

In Step S3, the vehicle control device 11 determines whether the automatic traveling start condition is met. Specifically, the vehicle control device 11 determines that the automatic traveling start condition is met when each of the following conditions are met: “the distance from the work start position S to the work vehicle 10 in the front-back direction is within X1 meters,” “distances on the left and right sides of the work vehicle 10 from the target route R to the work vehicle 10 are both within X2 meters,” “the angle formed by the orientation of the work vehicle 10 and the direction of the target route R is within Y1 degrees,” and “the remaining distance to a turning position of a straight path is Z1 meters or longer.” When the vehicle control device 11 determines that the automatic traveling start condition is met (S3: Yes), the vehicle control device 11 shifts the process to Step S4. When the vehicle control device 11 determines that the automatic traveling start condition is not met (S3: No), the vehicle control device 11 shifts the process to Step S2.

### Step S4

In Step S4, the vehicle control device 11 permits start of automatic traveling of the work vehicle 10. When the start of the automatic traveling is permitted, the operation terminal 20 displays an input button (start button K1) for the travel start instruction on the operation screen D2 (see FIG. 7), and enables reception of the travel start instruction from the operator.

### Step S21

On the other hand, when the communication state between the operation terminal 20 and the work vehicle 10 is the disconnection state, the vehicle control device 11 prohibits start of automatic traveling of the work vehicle 10 in Step S21. In this case, the start button K1 is not displayed or is displayed in a grayout state on the operation screen D2. The vehicle control device 11 shifts the process to Step S2 after Step S21. The vehicle control device 11 is prohibits start of automatic traveling while the communication state is the disconnection state, and permits start of automatic traveling when the communication state is put into the connection state.

### Step S5

In Step S5, the vehicle control device 11 determines whether the travel start instruction is acquired from the operation terminal 20. When the vehicle control device 11 acquires the travel start instruction (S5: Yes), the vehicle control device 11 shifts the process to Step S6. The vehicle control device 11 waits until the travel start instruction is acquired (S5: No).

### Step S6

In Step S6, the vehicle control device 11 starts automatic traveling of the work vehicle 10.

In the example shown in FIG. 3, the vehicle control device 11 starts automatic traveling of the work vehicle 10 according to the target route R from the work start position S.

### Step S7

In Step S7, the vehicle control device 11 determines whether the communication state between the operation terminal 20 and the work vehicle 10 is the connection state. When the vehicle control device 11 determines that the communication state is the connection state (S7: Yes), the vehicle control device 11 shifts the process to Step S9. On the other hand, when the vehicle control device 11 determines that the communication state is the disconnection state (S7: No), the vehicle control device 11 shifts the process to Step S8. The vehicle control device 11 monitors the communication state and executes a detection process during the automatic traveling.

### Step S8

In Step S8, the vehicle control device 11 determines, with respect to the automatic traveling permission condition, whether the setting in the first mode is configured. The vehicle control device 11 shifts the process to Step S81 when the setting in the first mode is configured (S8: Yes), and shifts the process to Step S9 when the setting in the second mode is configured (S8: No).

### Step S81

In Step S81, the vehicle control device 11 stops the automatic traveling of the work vehicle 10. That is, in the first mode, since the condition in which “the communication state between the operation terminal 20 and the work vehicle 10 is the connection state” is included in the automatic traveling continuation condition, when the communication state is put into the disconnection state (S7: No) during the automatic traveling, the vehicle control device 11 stops the automatic traveling of the work vehicle 10. The vehicle control device 11 shifts the process to Step S2 after Step S81.

When the process returns to Step S2, the vehicle control device 11 permits restart of the automatic traveling (Steps S4) on condition that the communication state is put into the connection state and the automatic traveling start condition is met (Step S2 and Step S3).

### Step S9

On the other hand, in the case where the communication state during the automatic traveling is the connection state (S7: Yes), or in the case where although the communication state is put into the disconnection state during the automatic traveling, the setting in the second mode is configured (S8: No), the vehicle control device 11 continues the automatic traveling of the work vehicle 10 and determines whether the work vehicle 10 has reached the work end position G. For example, when the work vehicle 10 has reached the work end position G, the vehicle control device 11 stops the automatic traveling. The vehicle control device 11 repeatedly executes the process from Step S7 to Step S9 until the work vehicle 10 has reached the work end position G (S9: No). Note that when the obstacle detection unit 17 detects an obstacle while the work vehicle 10 is automatically traveling and the automatic traveling is stopped, the vehicle control device 11 shifts the process to Step S1. The vehicle control device 11 executes the automatic traveling process as described above.

As described above, the automatic traveling system 1 according to the embodiment of the present invention is a system capable of causing the work vehicle 10 to automatically travel according to an instruction output from the operation terminal 20 (first operation device). In addition, the automatic traveling system 1 sets whether to include, in the automatic traveling permission condition for permitting automatic traveling, the condition in which “the communication state between the operation terminal 20 and the work vehicle 10 is the connection state where communication between the operation terminal 20 and the work vehicle 10 is established.”

According to the above configuration, when the setting to include, in the automatic traveling permission condition, the condition in which “the communication state between the operation terminal 20 and the work vehicle 10 is the connection state” is configured, for example, start of automatic traveling can be permitted or prohibited, and continuation of automatic traveling can be permitted or prohibited according to the communication state. On the other hand, when the setting not to include, in the automatic traveling permission condition, the condition in which “the communication state between the operation terminal 20 and the work vehicle 10 is the connection state” is configured, automatic traveling can be started or continued independent from the communication state.

Accordingly, convenience in automatic traveling of the work vehicle 10 can be improved.

### Additional Embodiment

As an additional embodiment of the present invention, the work vehicle 10 has a short-range mode (short-range monitoring mode) in which an operation of the work vehicle 10 can be controlled within a predetermined range from the work vehicle 10, and a long-range mode (long-range monitoring mode) in which an operation of the work vehicle 10 can be controlled (can be operated through cloud connection) via the communication network N1 (the Internet), and the vehicle control device 11 may be capable of setting and switching the short-range mode and the long-range mode. Note that the short-range mode may be a monitoring mode capable of controlling an operation of the work vehicle 10 through short-range communication, and the long-range mode may be a monitoring mode capable of controlling an operation of the work vehicle 10 through long-range communication. In addition, the short-range mode may be a remote controller mode, and the long-range mode may be a smartphone mode. In addition, the vehicle control device 11 can control an operation of the work vehicle 10 according to the set monitoring mode. For example, the operator can select the short-range mode or the long-range mode on the operation device 18 (see FIG. 4) provided in the cabin 138, or on the setting screen of the operation terminal 20 brought into the cabin 138 by the operator.

For example, the operator boards the work vehicle 10 while carrying the operation terminal 20 and prepares to start automatic traveling through a predetermined operation. When the operator is inside the work vehicle 10, sudden movement of the work vehicle 10 may be dangerous; therefore, the vehicle control device 11 prohibits start of automatic traveling via a remote operation device. In this case, the vehicle control device 11 permits start of automatic traveling only from the operation terminal 20 (short-range operation device).

In addition, when the operator gets out of the work vehicle 10 while carrying the operation terminal 20, the vehicle control device 11 allows the remote operation device to start automatic traveling, because no operator is in the vehicle. The communication state between the operation terminal 20 and the work vehicle 10 may be the connection state or may be the disconnection state in this case.

In addition, a condition in which “the communication state keeps a connection state until the operation terminal 20 moves a certain distance away from the work vehicle 10” may be included in the automatic traveling permission condition. Consequently, it is possible to ensure safety of the operator around the work vehicle 10. The certain distance may be set according to the communication state (radio signal intensity) between the operation terminal 20 and the work vehicle 10.

In addition, in a case where the work vehicle 10 starts automatic traveling, when the operation screen is displayed on the operation terminal 20, the vehicle control device 11 may continue the automatic traveling even when the communication state between a remote monitoring device and the work vehicle 10 is put into the disconnection state. Specifically, when the operation screen is displayed on the operation terminal 20, the vehicle control device 11 may determine that the operator is inside the work vehicle 10 or in the vicinity of the work vehicle 10 and can operate the operation terminal 20, and may continue automatic traveling independent from a remote monitoring terminal.

In addition, in a case where the work vehicle 10 starts automatic traveling, when the operation screen is not displayed on the operation terminal 20, the vehicle control device 11 determines that the operator cannot operate the operation terminal 20, permits automatic traveling when the communication state with the remote monitoring terminal is the connection state, and stops the automatic traveling when the communication state with the remote monitoring terminal is put into the disconnection state.

In addition, in a case where the work vehicle 10 is paused, when the operation screen is displayed on the operation terminal 20, the vehicle control device 11 may restart the automatic traveling in response to an operation on the operation terminal 20 even when the communication state with the remote monitoring terminal becomes the disconnection state.

In addition, in a case where the work vehicle 10 is paused, when the operation screen is not displayed on the operation terminal 20, the vehicle control device 11 prohibits restart of the automatic traveling when the communication state with the remote monitoring terminal is the disconnection state. Note that, in this case, the vehicle control device 11 may permit restart of the automatic traveling when either visual monitoring by the operator or monitoring through a camera image is possible.

### Supplementary Notes

The summary of the invention extracted from the embodiments is provided below as supplementary notes. Note that components and processing functions described in the following supplementary notes can be arbitrary selected and combined.

### Supplementary Note 1

An automatic traveling method capable of causing a work vehicle to automatically travel according to an instruction output from a first operation device, the method including
setting whether to include, in an automatic traveling permission condition for permitting automatic traveling, a condition in which a communication state between the first operation device and the work vehicle is a connection state where communication between the first operation device and the work vehicle is established.

### Supplementary Note 2

The automatic traveling method according to supplementary note 1, in which
in a case where a setting to include, in the automatic traveling permission condition, the condition in which the communication state is the connection state is configured, start and continuation of automatic traveling are prohibited when the communication state is a disconnection state; and
in a case where a setting not to include, in the automatic traveling permission condition, the condition in which the communication state is the connection state is configured, start and continuation of automatic traveling are permitted in each of a case where the communication state is the connection state and a case where the communication state is the disconnection state.

### Supplementary Note 3

The automatic traveling method according to supplementary note 1 or 2, in which
in the case where the setting to include, in the automatic traveling permission condition, the condition in which the communication state is the connection state is configured, when the communication state changes from the connection state to the disconnection state while the work vehicle is automatically traveling, the automatic traveling is stopped; and
in the case where the setting not to include, in the automatic traveling permission condition, the condition in which the communication state is the connection state is configured, when the communication state changes from the connection state to the disconnection state while the work vehicle is automatically traveling, the automatic traveling is continued.

### Supplementary Note 4

The automatic traveling method according to any of supplementary notes 1 to 3, which is capable of causing the work vehicle to automatically travel according to an instruction output from a second operation device different from the first operation device, in which
when a communication state between the second operation device and the work vehicle is the connection state, the setting not to include, in the automatic traveling permission condition, the condition in which the communication state between the first operation device and the work vehicle is the connection state is permitted; and
when the communication state between the second operation device and the work vehicle is the disconnection state, the setting not to include, in the automatic traveling permission condition, the condition in which the communication state between the first operation device and the work vehicle is the connection state is prohibited.

### Supplementary Note 5

The automatic traveling method according to any of supplementary notes 1 to 4,
setting whether to include, in the automatic traveling permission condition, the condition in which the communication state is the connection state, based on a position of the first operation device.

### Supplementary Note 6

The automatic traveling method according to supplementary note 5, in which
the setting to include, in the automatic traveling permission condition, the condition in which the communication state is the connection state is configured when the first operation device is located within a range less than a predetermined distance from the work vehicle; and
the setting not to include, in the automatic traveling permission condition, the condition in which the communication state is the connection state is configured when the first operation device is located within a range at least the predetermined distance away from the work vehicle.

### Supplementary Note 7

The automatic traveling method according to supplementary note 6, in which
the setting to include, in the automatic traveling permission condition, the condition in which the communication state is the connection state is configured when the first operation device is located inside the work vehicle; and
the setting not to include, in the automatic traveling permission condition, the condition in which the communication state is the connection state is configured when the first operation device is located outside the work vehicle.

### Supplementary Note 8

The automatic traveling method according to supplementary note 5, in which
the setting not to include, in the automatic traveling permission condition, the condition in which the communication state is the connection state is configured when the first operation device is located within a range less than a predetermined distance from the work vehicle; and
the setting to include, in the automatic traveling permission condition, the condition in which the communication state is the connection state is configured when the first operation device is located within a range at least the predetermined distance away from the work vehicle.

### Supplementary Note 9

The automatic traveling method according to supplementary note 8, in which
the setting not to include, in the automatic traveling permission condition, the condition in which the communication state is the connection state is configured when the first operation device is located inside the work vehicle; and
the setting to include, in the automatic traveling permission condition, the condition in which the communication state is the connection state is configured when the first operation device is located outside the work vehicle.

### Supplementary Note 10

The automatic traveling method according to any of supplementary notes 1 to 4,
setting whether to include, in the automatic traveling permission condition, the condition in which the communication state is the connection state according to a setting operation by an operator.

### Supplementary Note 11

The automatic traveling method according to any of supplementary notes 1 to 10, in which
in a case where the work vehicle automatically travels with an operator not on board, when the setting not to include, in the automatic traveling permission condition, the condition in which the communication state is the connection state is configured,
   start and continuation of automatic traveling are permitted when the operator having checked a captured camera image around the work vehicle is detected on the first operation device, and
   start and continuation of automatic traveling are prohibited when the operator having checked the camera image is not detected on the first operation device.

### Supplementary Note 12

The automatic traveling method according to any of supplementary notes 1 to 11,
causing a display unit of the first operation device to display, in an identifiable manner, whether the condition in which the communication state is the connection state is included in the automatic traveling permission condition.

### Supplementary Note 13

The automatic traveling method according to supplementary note 12,
causing the display unit of the first operation device to display information enabling identification of whether the condition in which the communication state is the connection state is included in the automatic traveling permission condition.

### REFERENCE SIGNS LIST

1 Automatic traveling system
10 Work vehicle
11 Vehicle control device
18 Operation device (second operation device)
19 Remote controller (second operation device)
111 Travel processing unit
112 Setting processing unit
20 Operation terminal (first operation device)
211 Setting processing unit
212 Output processing unit
213 Display processing unit
D1 Menu screen
D2 Operation screen
D3 Operation device setting screen
D4 Operation screen
F Field
K1 Start button
K2 Pause button
M1 Message
P1 Camera image

1. An automatic traveling method capable of causing a work vehicle to automatically travel according to an instruction output from a first operation device, the method comprising:
setting whether to include, in an automatic traveling permission condition for permitting automatic traveling, a condition in which a communication state between the first operation device and the work vehicle is a connection state where communication between the first operation device and the work vehicle is established.

2. The automatic traveling method according to claim 1, wherein:
in a case where a setting to include, in the automatic traveling permission condition, the condition in which the communication state is the connection state is configured, starting of and continuation of automatic traveling are prohibited when the communication state is a disconnection state; and
in a case where a setting not to include, in the automatic traveling permission condition, the condition in which the communication state is the connection state is configured, starting of and continuation of automatic traveling are permitted in each of a case where the communication state is the connection state and a case where the communication state is the disconnection state.

3. The automatic traveling method according to claim 1, wherein:
in the case where the setting to include, in the automatic traveling permission condition, the condition in which the communication state is the connection state is configured, when the communication state changes from the connection state to the disconnection state while the work vehicle is automatically traveling, the automatic traveling is stopped; and
in the case where the setting not to include, in the automatic traveling permission condition, the condition in which the communication state is the connection state is configured, when the communication state changes from the connection state to the disconnection state while the work vehicle is automatically traveling, the automatic traveling is continued.

4. The automatic traveling method according to claim 1, which is capable of causing the work vehicle to automatically travel according to an instruction output from a second operation device different from the first operation device, wherein:
when a communication state between the second operation device and the work vehicle is the connection state, the setting not to include, in the automatic traveling permission condition, the condition in which the communication state between the first operation device and the work vehicle is the connection state is permitted; and
when the communication state between the second operation device and the work vehicle is the disconnection state, the setting not to include, in the automatic traveling permission condition, the condition in which the communication state between the first operation device and the work vehicle is the connection state is prohibited.

5. The automatic traveling method according to claim 1, wherein setting whether to include, in the automatic traveling permission condition, the condition in which the communication state is the connection state, is based on a position of the first operation device.

6. The automatic traveling method according to claim 5, wherein:
the setting to include, in the automatic traveling permission condition, the condition in which the communication state is the connection state is configured when the first operation device is located within a range less than a predetermined distance from the work vehicle; and
the setting not to include, in the automatic traveling permission condition, the condition in which the communication state is the connection state is configured when the first operation device is located within a range at least the predetermined distance away from the work vehicle.

7. The automatic traveling method according to claim 5, wherein:
the setting not to include, in the automatic traveling permission condition, the condition in which the communication state is the connection state is configured when the first operation device is located within a range less than a predetermined distance from the work vehicle; and
the setting to include, in the automatic traveling permission condition, the condition in which the communication state is the connection state is configured when the first operation device is located within a range at least the predetermined distance away from the work vehicle.

8. The automatic traveling method according to claim 1, wherein setting whether to include, in the automatic traveling permission condition, the condition in which the communication state is the connection state is according to a setting operation by an operator.

9. The automatic traveling method according to claim 1, wherein in a case where the work vehicle automatically travels with an operator not on board, when the setting not to include, in the automatic traveling permission condition, the condition in which the communication state is the connection state is configured:
start and continuation of automatic traveling are permitted when the operator having checked a captured camera image around the work vehicle is detected on the first operation device, and
start and continuation of automatic traveling are prohibited when the operator having checked the camera image is not detected on the first operation device.

10. The automatic traveling method according to claim 1, further comprising causing a display unit of the first operation device to display, in an identifiable manner, whether the condition in which the communication state is the connection state is included in the automatic traveling permission condition.

11. A non-transitory, computer-readable medium storing instructions, which when executed by a processor, cause the processor to perform operations including:
causing a work vehicle to automatically travel according to an instruction output from a first operation device; and
setting whether to include, in an automatic traveling permission condition for permitting automatic traveling, a condition in which a communication state between the first operation device and the work vehicle is a connection state where communication between the first operation device and the work vehicle is established.

12. An automatic traveling system configured to perform operations including:
causing a work vehicle to automatically travel according to an instruction output from a first operation device; and
setting whether to include, in an automatic traveling permission condition for permitting automatic traveling, a condition in which a communication state between the first operation device and the work vehicle is a connection state where communication between the first operation device and the work vehicle is established.
